(19) United States
(12) Patent Application Publication
(10) Pub. No.: US 2026/0262625 A1
(43) Pub. Date: Sep. 10, 2026

(54) SECTION OF BOOM FOR SPRAYING A PRODUCT ONTO A PLANT TARGET, SPRAY BOOM AND AGRICULTURAL SPRAYER

(71) Applicant: PELLENC, PERTUIS (FR)

(72) Inventors: Pierre GAUFFRE, PERTUIS (FR); Sylvain CLOAREC, CADENET (FR)

(21) Appl. No.: 18/871,902

(22) PCT Filed: Jun. 8, 2023
(86) PCT No.: PCT/IB2023/055941

§ 371 Date: Dec. 5, 2024

(30) Foreign Application Priority Data
Jun. 8, 2022 (FR) FR2205499

(51) Int. Cl. A01M 7/00

(52) U.S. Cl. CPC A01M 7/0071; A01M 7/0014; A01M 7/006

(57) ABSTRACT

Disclosed is a section of a boom for spraying a product over a plant target, the boom section having at least one spraying element configured to be fluidly supplied with product and to generate a product jet propagating towards the plant target according to a median spraying axis. Two diffusers are each configured to be supplied with a gaseous fluid such as air and each configured to generate at the diffuser outlet a diffused air flow propagating towards the plant target according to a diffused air flow direction, the spraying element being located between the two diffusers. The boom section is configured so that each of the diffused air flows intersects the median spraying axis. Also disclosed are a spraying boom and an agricultural sprayer integrating this boom section, as well as a method using such a boom.

### TECHNICAL FIELD

The present invention relates to the field of systems for spraying treatment products, in particular for spraying phytosanitary products over plant targets, for example hedgerows. More specifically, it relates to a spraying boom section of a spraying boom intended to be carried by an agricultural sprayer and comprising elements for spraying a product to be sprayed. It finds a particularly advantageous, yet non-limiting, application for spraying a slurry over a vine hedgerow.

### PRIOR ART

Several types of solutions for spraying a product over a plant target exist.

A first spraying system type uses projected jets. These systems comprise nozzles which, when supplied under pressure with a product to be sprayed, ensure a fragmentation of the product into droplets. The sprayed product jets are directed towards the vegetation to be treated in the form of small-size droplets. They reach their plant target thanks to their own speed. Nonetheless, this system does not enable a distribution of the droplets over the entire surface of the plant target, in particular in depth of the plant hedgerow and over the intrados of the leaves.

A second spraying system type, so-called pneumatic system, operates without a fragmentation nozzle and comprises blowing means adapted to generate an air flow at a very high speed at the level of the intake of the product phytosanitary which is then fragmented and distributed in the air flow by the high depression generated by the air speed. Thus, the very high speed air flow favors a rapid transport and penetration of the droplets within the vegetation. Nonetheless, in case of absence of vegetation or low vegetation density, the phytosanitary product is propelled at a long distance, thereby polluting the environment. In fact, recovery panels are most often necessary to limit the environmental pollution.

A third system type, so-called carried jet system, comprises blowing means generating a large-volume air flow combined with spraying nozzles. In this case, the nozzles ensure a fragmentation of the sprayed jets into droplets directed towards the air flow, which thus ensures transport thereof rapidly towards the plants to be treated. This system has the drawback of not homogeneously distributing the product over the entire surface of the plant target, in particular the intrados of the leaves, and might pollute the environment in case of absence of a plant target.

There are also spray systems carried at the back of a user described in document EP2679092. In this system, the nozzle is directionally handled by hand in order to project towards the vegetation. However, the manual handling of the nozzle results in an uncontrolled and thus inaccurate projection distance.

Document FR3074016, supplemented by document FR3074014, describes a carried jet type system wherein an air flow carries a propellant air up to a nozzle. The nozzle herein includes, on the one hand, a louver for diffusing the propellant air oriented towards the plant target and, on the other hand, a burst nozzle or a sprinkler for fragmenting and diffusing the phytosanitary product in the propellant air. The nozzle of this document ensures both a function of shaping the propellant air flow and also a function of fragmenting the product introduced into the propellant air flow to be dispensed towards the plants to be treated. The nozzle is mounted on a nozzle carrier such as a boom, the nozzle carrier could further include openings able to generate upstream and downstream air curtains on either side of the nozzle, at a distance from the propellant air flow and without interacting with the latter, to spread the foliage away and/or to recover any drops of phytosanitary liquid having bounced on the foliage. Nonetheless, the multiplicity of air flows in presence requires considerable powers to generate them.

Despite the numerous solutions already proposed, there is still a need to make the spraying of a product over a plant target more efficient

This is an object of the present invention.

The other objects, features and advantages of the present invention will become apparent upon examining the following description and the appended drawings. It should be understood that other advantages could be incorporated.

### SUMMARY

To achieve this objective, according to one embodiment, a section of a boom for spraying a product over a plant target, for example a vine, is provided. It could be referred to hereinafter simply as boom section and comprises at least one spraying element, such as a nozzle, configured to be fluidly supplied, preferably under pressure, with a product and to generate, preferably in the form of drops, a product jet propagating towards the plant target according to a median spraying axis. The boom section also comprises two diffusers each configured to be supplied with a gaseous fluid such as air and each configured to generate, at the outlet of the diffuser, a diffused air flow propagating towards the plant target according to a diffused air flow direction, the spraying element being located between the two diffusers.

According to one example, the boom section is configured so that each of the diffused air flows has a first portion which propagates according to its diffused air flow direction and which intersects the median spraying axis, each of the diffused air flows having a second portion extending the first portion beyond the intersection with the median spraying axis.

Thus, according to this example, each diffused air flow has:
a first portion, so-called the carrier air flow portion, converging in the direction of the median spraying axis while channeling the product jet, the carrier air flow portion intersecting the median spraying axis upstream of the plant target,
a second portion, so-called the collision portion, extending the first portion beyond the intersection with the median spraying axis, over which the two carrier air flow portions collide with one another to create turbulences and generate a turbulent air flow. This turbulent air flow propagates towards and within the plant target.

The product flow, centered in the direction of the median spraying axis, incorporates its drops progressively in the carrier air flow portions and completely in the collision portions.

Thus, the proposed boom section allows, thanks to the carrier air flow portions converging towards the median spraying axis, channeling and then incorporating by pinching the product jet upstream of the plant target, and, thanks to the collision portions, generating turbulences able to slow down and diffuse the drops more homogeneously by locating them over the different surfaces of the plant target. Thus, the phytosanitary product can deposit more easily over the two faces of a leaf set in movement by turbulences, irrespective of the orientation of the leaf in space, but also promote, by this movement, the penetration of the drops to the core of the plant target to reach the fruits and the wood supporting them. Thus, this solution allows considerably improving the effectiveness of spraying of the product over the plant target, whether it consists of viticulture, arboriculture or market-gardening culture.

Furthermore, in the context of the development of the present invention, it has been found that the proposed solution allows avoiding a considerable drift of the product in case of small surfaces to be treated in the plant target, or in case of a punctual absence of plant targets, for example in case of local absence of vine stocks in a vine row. Indeed, the convergent carrier air flow portions allow, in a first step, channeling and then incorporating, by pinching the product jet, the drops emitted by the spraying element while limiting the influence of the disturbances due to the speed of advance of the boom section or to the wind. Then, in the collision portion, the two diffused air flows generate turbulences and merge into a turbulent air flow preferably beginning upstream of the plant target, which turbulences will then, on the one hand, slow down the diffused air flows and therefore the average speed of the drops in the direction of the median spraying axis and, on the other hand, spread the foliage away from the plant target to promote penetration and deposition of the product on the different surfaces within the plant target. Thus, the slowing down of the drops in the collision portion and in the direction of the median spraying axis limits their reach beyond the theoretical area of presence of the plant target.

In the proposed boom section, the diffused air flows do not act like independent air curtains able to recover any drops having bounced on the plant target. The diffused air flows also do not act as independent air curtains intended to spread the foliage away upstream of the median spraying axis to promote the passage of the product jet. On the contrary, during the development of the present invention, it has been found that it is the convergence of the diffused air flows with the product jet upstream of the plant target which actually improves the deposition of the drops of product on the different surfaces of the plant target and avoids projection thereof away from the plant target in case of interruption of the latter or an excessively low density. If the diffused air flows act like simple curtains to spread the foliage away without intercepting or slowing down the product jet, then, as soon as the plant mattress is interrupted or too sparse, the drops of product would be propelled in the direction of the median spraying axis well beyond the row of the plant target given the speed and the direction imposed by the product jet and/or by the diffused air flows. The dissemination of the product would then be insufficiently controlled and would be harmful to the environment.

Depending on the type of treated hedgerow, for example narrow vines or wide vines, the minimum recommended spraying distance between a spraying element and the plant target may be different. Thus, each type of hedgerow may require adapting the geometry of the diffusers of a boom section to the type of hedgerow to be treated so that the collision portion of the diffused air flows could begin during the treatment operation generally upstream of the plant target. Hence, the diffusers are advantageously configured prior to the treatment operation so that the collision portion begins at a distance smaller than the minimum recommended spraying distance, and therefore theoretically upstream of the plant target. The distance between the spraying element and the collision portion could also be not adjustable but it is sized in this case so as to be suitable for different types of plant targets to be treated.

Another aspect relates to a spraying boom, which could hereinafter be simply so-called a boom, comprising at least one boom section as indicated hereinabove and at least one fluid source for generating a boom air flow. The spraying boom also comprises at least one coupling sleeve for fluidly connecting the source to the at least one spraying boom section, the at least one coupling sleeve and the at least one boom section forming a duct for the circulation of the boom air flow within the boom. The sleeve extends according to a preferred direction. The pivot axis is perpendicular to this direction.

According to one example, the boom section comprises at least one connecting sleeve connected to the spraying body, and configured so that the boom air flow flows from an inlet of one amongst the spraying body and the connecting sleeve to an outlet of the other one amongst the body and the connecting sleeve according to a boom air flow direction.

According to a non-limiting example, the fluid source is a fan. Preferably, the fan is an axial fan mounted at one end of the duct for the circulation of the boom air flow of the boom. It may also be configured to be mounted in a cylindrical portion of the duct for the circulation of the boom air flow.

Another aspect relates to an agricultural sprayer, self-propelled or towed, equipped with at least one boom as indicated hereinabove.

According to a non-limiting example, the agricultural sprayer comprises at least two booms, each boom having a fan whose air flow rate can be adjusted independently of that of the other boom. Thus, it is possible to adjust the boom air flow delivered in each of the booms independently. It is also possible to adjust the diffused air flows delivered by the diffusers of each of the booms, for example according to the position of the boom section with respect to the plant target. Moreover, in comparison with a solution comprising one single fan supplying several booms, the proposed solution avoids, on the one hand, pressure drops in conveying air between the fan and a boom and, on the other hand, avoids generating different pressure drops towards each of the booms, given the lengths and shapes of the duct required to convey the boom air flow. Furthermore, the proposed solution allows facilitating the replacement of a boom, for example with a boom with a different number of boom sections, a boom having nozzles of different calibers or a boom having a different adjustment of the minimum recommended spraying distance, which could also have different distances between the spraying elements of two boom sections. According to one example, the fan is an axial fan mounted at one end of the boom in the axis of the boom using one coupling sleeve. The axis of the boom corresponds to an axis according to which the boom extends mainly. The axial fan may also be integrated directly into a cylindrical portion of the duct for the circulation of the boom air flow of the boom.

Another aspect relates to a method for spraying a product over a plant target using at least one spraying boom section of a boom as indicated hereinabove or an agricultural sprayer as indicated hereinabove. This method comprises the following steps:
The spraying element is supplied with product under pressure to generate a product jet propagating towards the plant target according to a median spraying axis,
The two diffusers, positioned on either side of the spraying element, are supplied with a gaseous fluid such as air to generate at the outlet of each diffuser a diffused air flow propagating towards the plant target according to a diffused air flow direction.

Preferably, the two diffusers are supplied simultaneously. One of the two diffusers may be positioned upstream of the spraying element and the other one of the two diffusers may be positioned downstream of the spraying element according to the direction of travel of the boom with respect to the plant target.

Each diffuser is oriented so as to diffuse a diffused air flow converging towards the median spraying axis, the two diffused air flows meeting preferably upstream of the plant target. Preferably, the two diffused air flows meet at a distance smaller than the recommended minimum spraying distance.

A first portion, so-called the carrier air flow portion, converges towards the median spraying axis while channeling the product jet and has a second portion, so-called the collision portion, extending the first portion beyond the meeting point between the two diffused air flows.

The diffused air flows converge and each forms a carrier air flow channeling the product jet over their first portion until they meet at the beginning of the collision portion upstream of the plant target. The diffused air flows are configured to accompany the product jet in their first portion up to the plant target while progressively pinching the product jet and then to generate turbulences in the collision portion, slowing down the general propagation of the drops in the median spraying axis, distributing and arranging the drops on the different surfaces of the plant target. Thus, the collision between the diffused air flows and the product jet allows, on a first portion of the pathway of the drops, conveying these very rapidly towards the plant target to prevent them from drying, then, on a second portion of the pathway of the drops, slowing them considerably by reorienting them in space thanks to the turbulences to avoid propagation thereof beyond the target and to favor application thereof over all of the surfaces of the target.

The width of each diffused air flow, considered perpendicularly to the direction of advance of the boom, at the intersection with the median spraying axis should be at least equivalent to the width of the product jet pinched at this level to incorporate the drops into the collision portion. These widths are measured in a plane perpendicular to the median spraying axis, this plane being considered at the level of the collision area. Typically, this area is located with respect to the spraying element at a distance smaller than the minimum recommended spraying distance between the spraying element and the plant target.

### BRIEF DESCRIPTION OF THE FIGURES

The aims, objects, as well as the features and advantages of the invention will appear more clearly from the detailed description of an embodiment of the latter which is illustrated by the following appended drawings, wherein:

FIG. 1 shows an example of an agricultural sprayer including a plurality of booms for spraying a product over plant targets.

FIG. 2 shows a spraying boom according to an example of the present invention, provided with three spraying boom sections.

FIGS. 3A and 3B respectively show, in perspective and top views, a boom section, as well as the product jets and the diffused air flows emitted by the body of the boom section in the direction of a plant target.

FIG. 3C schematically illustrates the propagation of a product jet and of diffused air flows, in front and sectional view.

FIG. 4 shows, in perspective view, a detailed example of a boom section of a boom illustrated in FIG. 2.

FIG. 5 shows, in perspective sectional view, the boom section illustrated in FIG. 4.

FIGS. 6A to 6C are perspective and sectional views of a boom section similar to FIG. 4, and allowing visualizing more specifically an example of members for adjusting the flow rate of the diffused air flows.

FIGS. 7A and 7B are perspective views of the boom section illustrated in FIGS. 6A to 6C allowing visualizing more specifically an example of adjustment of an angular orientation of the air diffusers.

FIG. 8 is a perspective and exploded view of a spraying boom according to a second embodiment of the boom air flow duct.

The drawings are given as examples and do not limit the invention. They consist of schematic representations of principle intended to facilitate understanding of the invention and are not necessarily plotted to the scale of practical applications.

### DETAILED DESCRIPTION

Before starting a detailed review of embodiments of the invention, optional features that could optionally be used in combination or alternatively are set out hereinafter:

The diffusers are oriented such that each of the diffused air flows has a first portion which propagates according to its diffused air flow direction and which intersects the median spraying axis, each of the diffused air flows having a second portion extending the first portion beyond the intersection with the median spraying axis.

According to one example, the spraying boom section is configured so that the median spraying axis intersects the collision portion at a distance Db from the spraying element smaller than 0.8 meters and preferably smaller than 0.4 meters. Preferably, this distance is measured at the outlet of the spraying element according to the median spraying axis.

According to one example, the boom section is configured so that a first diffuser diffuses the diffused air flow upstream of the spraying element and a second diffuser diffuses the diffused air flow downstream of the spraying element according to a direction of advance of the spraying boom.

According to one example, the spraying boom section comprises a body, the spraying element and the diffusers are rotatably mounted on the body so as to be orientable about a common axis of rotation, the spraying element and the diffusers being mutually secured in rotation about this axis of rotation. This axis of rotation is qualified as a pivot axis.

According to one example, the pivot axis is perpendicular to the median spraying axis according to which the product jet propagates.

The configuration of this pivot axis allows orienting the product jet accurately and while adapting to the dimensions of the hedgerow to be treated. This addresses the problem of treating a hedgerow more effectively. This is particularly advantageous for a boom section carried by a self-propelled or towed machine. This type of self-propelled or towed machine allows treating a very large length of hedgerow within a short time period. In this sense, it radically differs in its approach and in its objectives from tools worn at the back of a human and enabling the user to manually orient the product jet towards a chosen direction of the hedgerow. In general, these tools require the user to perform a sweeping movement in order to treat the entire surface of the hedgerow.

According to one example, the pivot axis is substantially perpendicular to the direction according to which the spraying body extends from an inlet of the body up to an outlet of the body.

According to one example, the pivot axis is configured to enable a rotation of the two diffusers so that the diffused air flows sweep an angular sector, this angular sector being contained within a plane, preferably a vertical plane.

According to one example, the pivot axis is preferably parallel to a preferred direction of advance of the agricultural sprayer.

For example, this rotation allows orienting the median spraying axis in a plane comprising the median spraying axis and perpendicular to the pivot axis, for example upwards or downwards in the case of a spraying boom arranged vertically, while keeping the relative positioning of the spraying element and of the diffusers. This rotational adjustment allows orienting the product jet according to the position of the plant target with respect to the boom section. This adjustment also allows adjusting the boom sections of the same boom to cover the entire plant target, this adaptation taking account of the dimension of the hedgerow to be treated as well as the number of spraying sections of the boom. Preferably, the pivot axes of each boom section of the same boom are parallel and preferably horizontal.

According to one example, the spraying boom section comprises a support part extending from one diffuser to another and carrying the spraying element. Thus, the median spraying axis is related to the directions of the diffused air flows defined by the diffusers.

According to one example, the spraying element is located at an equal distance from the diffusers.

According to one example, the spraying boom section is configured so that each of the diffused air flows intersects the median spraying axis at two contiguous areas or at the same area, preferably at the same point. Thus, the diffused air flows intersect each other on the median spraying axis. This embodiment allows increasing the reach of the product jet without modifying, at least without significantly modifying, its direction. This advantage is even more significant if the two diffused air flows have identical flow rates and angles of incidence at the intersection point. Alternatively, the spraying boom section is configured so that each diffused air flow intersects the median spraying axis at two distinct areas, separated from each other. This embodiment allows further limiting the speed of propagation of the drops in the direction of the median spraying axis by diverting their trajectory beforehand by orienting the first diffused air flow intersecting the median spraying axis before incorporating them in the collision portion.

According to one example, the boom section comprises a body. The body forms at the level of the boom section a tubular portion having at least one inlet configured to receive the boom air flow and at least one supply opening of the diffusers to generate the diffused air flows. Preferably, the tubular portion also comprises at least one outlet configured to evacuate the portion of the boom air flow that has not propagated through the diffusers. The boom section may comprise a section sleeve recovering the boom air flow portion that has not propagated through the diffusers to connect it to another boom section.

The diffusers are located on either side of the body. Preferably, they are located symmetrically with respect to a center of the body. Preferably, the diffusers are symmetrical parts so as to alternately form either one of the diffusers. This allows reducing the number of references for making the same spraying boom section, which limits the manufacturing, logistics and after-sales service costs.

According to one example, at least one diffuser has a proximal end through which it is rotatably mounted on the body and a distal end forming at least one outlet for the diffused air flow, the diffuser may further have an outer flange, a wall of which partially channels the diffused air flow upon passage thereof inside the diffuser, the outer flange may have a curved shape tending to bring the distal end closer to the body. This primarily allows facilitating mounting of the diffusers on the body and ensuring mounting from outside the outer flanges while limiting pressure drops in the diffuser. Then, this allows having a compact spraying boom section to limit the risks of damage when encountering vegetation or obstacles.

According to one example, at least one diffuser has:
a proximal chamber extending from the proximal end of the diffuser and in fluid communication with one of the supply openings of the body,
a distal chamber extending from the proximal chamber and up to the outlet of the diffused air flow.

At least the distal chamber has several channels configured to separate the diffused air flow flowing in the diffuser into several diffused air flow portions to limit the interactions and therefore the turbulences in the diffused air flow through the diffuser, each channel forming a diffused air flow portion, at least one of the portions of the first carrier air flow portion being intended to intersect the median spraying axis, the other portions being oriented according to preferred directions, preferably not parallel to each other but also to the median spraying axis, substantially fan-like shaped so as to form together a barrier, at least lateral, to the spray jet. At least two adjacent channels channel their respective diffused air flow portions according to non-parallel preferred directions. Nonetheless, this allows forming the carrier air flow portion with homogeneous air speeds, limiting the energy losses due to the internal turbulences of the diffused air flow.

According to one example, the distal chamber has a central channel and two peripheral channels creating diffused air flow portions of the diffused air flow, extending from each channel, the central diffused air flow portion derived from the central channel intersecting at least the median spraying axis and all of the diffused air flow portions forming the diffused air flow and forming a lateral barrier to the product jet.

According to one example, the body is rigid. In particular, it is rigid enough so as not to be manually deformable.

According to one example, the body is made into two portions that are symmetrical to each other. The assembly into two portions has the advantage of facilitating mounting of the diffusers and of the spraying element.

According to one example, the spraying boom section is provided with a spraying support for positioning a spare spraying element arranged on the body.

According to one example, the spraying boom section includes a device for adjusting the diffused air flow at the diffuser outlet. Preferably, the adjustment device includes at least one flap movably mounted inside the body and configured to vary, according to its position in the body, the portion of the boom air flow present inside the body and which reaches at least one diffuser via the supply openings. According to one example, the flap is configured to limit the boom air flow portion diverted in the direction of the supply opening via the supply openings. According to one example, the flap can take on a closed position in which it prevents the boom air flow present inside the body from reaching at least one diffuser. Preferably, the spraying boom section comprises a flap for each diffuser.

According to one example, the spraying boom section comprises an adjustment member which can be handled by a user from outside the body and configured to vary the position of the at least one flap. Preferably, one single adjustment member varies the position of the flaps associated with all of the diffusers of the boom section.

According to one example, the spraying boom section comprises a body, the body forms, at the level of the boom section, a tubular portion having at least one inlet and at least one outlet between which the rail air flow flows, and at least one supply opening of the diffusers to generate the diffused air flows, the spraying boom section is further configured to support a main supply duct of the product spraying element, the main duct passes through at least one inlet and one outlet of the body. Alternatively, the main supply duct is accommodated inside a housing formed on an outer face of the body. In this case, preferably, the main duct does not project beyond the outer face of the body. These embodiments have the interest of protecting the duct inside the boom section. Thus, the risks of tear-off, or piercing, of the duct on contact with the vegetation or other obstacles, are avoided.

Of course, it clearly appears that the features related to the presence and the arrangement of the main supply duct can be exploited and claimed independently of the features related to the air flow portions which intersect the median spraying axis as well as the features related to the pivot axis.

Alternatively, the spraying boom section is configured so that the duct is connected to the spraying element while passing through the outside of the tubular portion of the body. This allows making the supply connectors of the spraying element accessible and checking up for any leaks.

According to one example, the spraying boom section comprises a body and may further comprise a connecting sleeve connected to the body, the air flowing from an inlet of one amongst the body and the connecting sleeve to an outlet of the other one amongst the body and the connecting sleeve, a portion of the boom air flow being diverted towards the diffusers. Afterwards, the connecting sleeve is connected to another spraying boom section while defining a distance between two nozzles of the same boom. The connecting sleeve may be rigid or flexible.

According to one example, the product jet has, in section in a plane perpendicular to the median spraying axis, a solid or annular section. The product jet may also have, in section in a plane perpendicular to the median spraying axis, a circular, elliptical or polygonal perimeter depending on the nozzle of the used type of spraying element. The section of the product jet, considered in section in a plane perpendicular to the median spraying axis and in the absence of the carrier air flow portion, generally increases along the median spraying axis away from the spraying element, at least over a portion of this median axis, preferably over at least one meter. For example, the spraying is in the form of drops. The diffused air flows are configured to intersect and incorporate the drops of the product jet along the carrier air flow portion and, in the worst case, in the collision portion.

According to one example, the spraying boom section has a hollow body forming a one-piece part. The sleeve is fluidly connected to the body in a removable manner. According to one alternative, the boom section includes two portions, each forming a portion of the sleeve and a portion of the spraying body, the cooperation of these two portions defining a duct for the circulation of the boom air flow by forming the sleeve and the spraying body. According to one example, each portion forms a half-shell. Preferably, the two portions are identical. This allows reducing the number of references for making the same spraying body, which limits the manufacturing and logistics costs.

According to one example, the connecting sleeve is flexible, preferably the connecting sleeve is flexible enough to deform under the effect of the weight of at least three boom sections and preferably under the effect of the weight of at least one boom section. Typically, the sleeve is flexible enough to deform under the effect of its own weight when it has a length longer than 0.5 meters. Thus, the boom can deform when it encounters an obstacle, which considerably reduces the risks of breakage. Furthermore, the flexibility of the sleeves enables the boom to keep a substantially vertical orientation, irrespective of the declivity of the terrain, which allows spraying the plant target more accurately.

According to one example, in use, the boom extends mainly according to a vertical direction.

According to one example, the boom comprises at least two boom sections, and preferably at least three boom sections, interconnected by their connecting sleeve and arranged in series so that a portion of the boom air flow supplying a first spraying boom section passes therethrough up to the last boom section while supplying the different diffusers.

According to one example, each spraying boom section is removably mounted on the boom. This allows easily adapting the configuration of the boom (for example the number and the arrangement of the boom sections on the same boom) according to the plant target and the amount of treatment to be sprayed. Furthermore, in case of failure of a boom section, it can be easily replaced without having to replace the entire boom.

According to one example, the spraying element generates a product jet in the form of drops. According to one example, the spraying element generally emits a product jet designed to flare out, in the absence of a diffused air flow, within a vertical angular range in the range of 80 to 90 degrees in the case of a boom arranged vertically. Thus, this leads to sweeping the plant mattress over a width defined by this angular range combined with the distance between the outlet of the spraying element and the plant target to be treated. In fact, to cover the entirety of the plant target, several nozzles are necessary in a superposed manner, hence the need to position at least two nozzles and most often three or four, and even more, depending on the type of pipe of the vineyard or of the hedgerow to be treated.

According to one example, the sprayer is configured so that the median spraying axis intersects the diffused air flows at a distance Db from the spraying element, with Db≤Dr, Dr being a minimum spraying distance recommended by the manufacturer, measured according to the median spraying axis between the spraying element and the plant target.

The terms “substantially”, “about”, “in the range of” mean “within a 10% margin”, preferably “within a 5% margin” or, when it consists of an angular orientation, “within a 10° margin”. Thus, a direction substantially normal to a plane means a direction having an angle of 90±10° with respect to the plane.

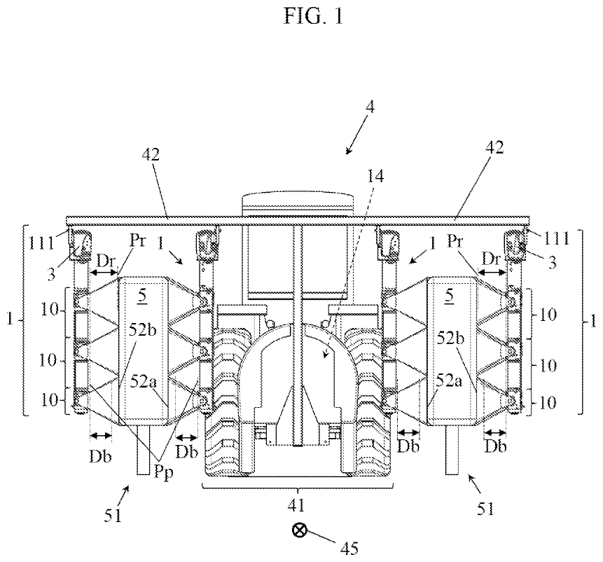

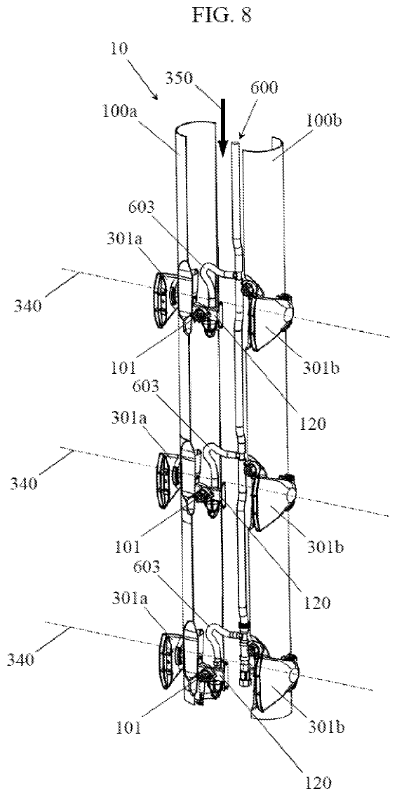

An embodiment of the present invention will now be described with reference to FIGS. 1 to 7B in a first embodiment and with reference to FIG. 8 in a second embodiment.

FIG. 1 illustrates a rear view of an agricultural sprayer 4 during work. This agricultural sprayer 4 comprises a load-carrying structure 41 provided with moving members such as wheels or tracks. The agricultural sprayer 4 comprises at least two arms 42 which extend on each side of the load-carrying structure 41. Each arm 42 supports two spraying booms 1 intended to spray a product, for example, a phytosanitary product such as a slurry, over a plant target 5 such as a hedgerow 51. The slurry is stored in a tank 14 and conveyed towards the spraying booms 1 by means of pipelines which are not shown FIG. 1. These spraying booms 1 are sufficiently spaced apart so as to be moved according to a preferred direction of advance 45 along the plant target 5 while spraying the product over two opposite faces 52a, 52b of the plant target 5. They are configured by the manufacturer to spray the product at a minimum recommended spraying distance Dr from the emission of the product jet, this distance Dr allowing ensuring a complete sweep of the plant target by all of the spraying elements of the boom. In fact, the booms are configured so that this minimum distance is complied with under normal working conditions (excluding driving deviations of the towing vehicle, for example).

Of course, the agricultural sprayer illustrated in FIG. 1 is a non-limiting example. The invention covers agricultural sprayers which comprise only one spraying boom 1 or which comprise more than two booms on each arm. It also covers agricultural sprayers requiring the arrangement of the spraying booms horizontally (to treat market-gardening cultures, for example) or inclined with respect to the horizontal (to treat arboriculture hedgerows, for example).

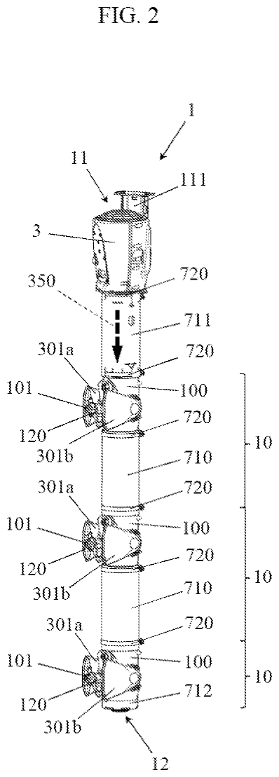

The spraying boom 1 is illustrated in FIG. 2.

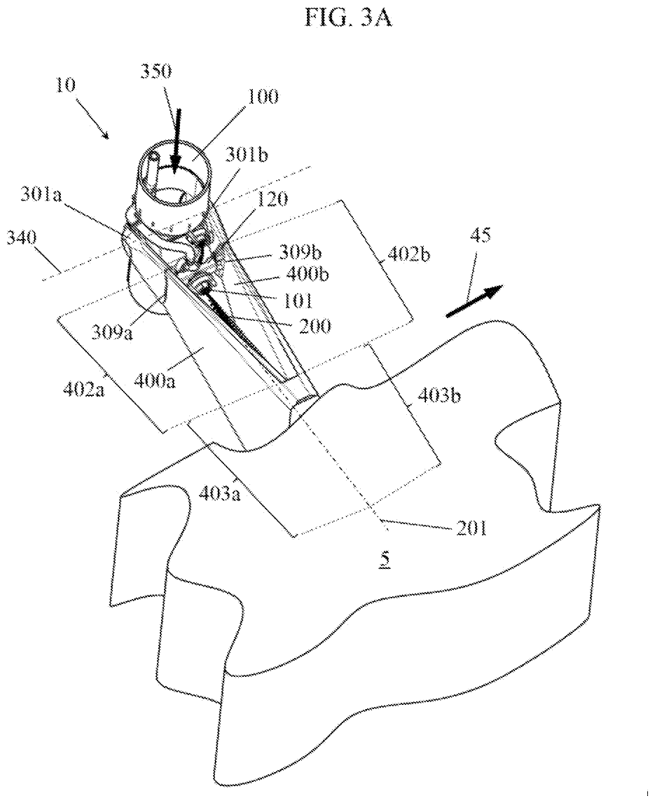

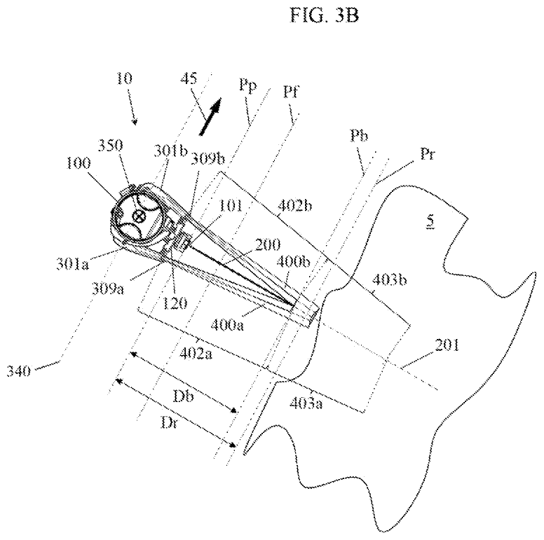

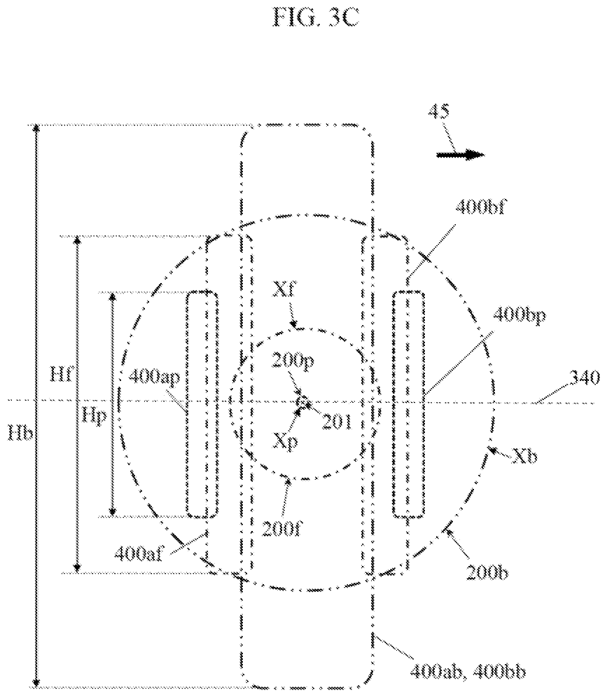

The spraying boom 1 extends from a proximal end 11 up to a distal end 12. In the illustrated example, the proximal end 11 is provided with a fastening member 111 intended to fasten the boom to an arm 42 of the agricultural sprayer 4. The boom 1 comprises three boom sections 10, each comprising a spraying body 100 supporting spraying means such as a spraying element 101 configured to emit a product jet as well as two diffusers 301a, 301b of diffused air flow. This spraying body 100 will be described in detail with reference to FIGS. 3A to 7B. The spraying body 100 associated with its spraying means is configured to spray a product over a given area of the plant target 5.

The spraying element delivers a product jet 200 in the form of drops, shown in FIGS. 3A and 3B. In the retained example, the spraying element is a nozzle 101 supplied with a pressurized product. The nozzle includes, in a known manner, a nozzle which, combined with the pressure imparted to the product, generates a jet of drops directed in a direction perpendicular to the nozzle and with a shape imposed by the geometry of the nozzle. This spraying element could also consist of a simple liquid outlet which would be exploded into drops by means of a specific air flow, or an electrically-controlled nozzle delivering, for example, a product jet in a pulsed manner. For brevity, in the remainder of the description, the spraying element at the source of the product jet will be qualified as a nozzle 101 irrespective of its type.

The boom section 10 also comprises a connecting sleeve 710 interconnecting two boom sections or a boom plug 712 when the boom section is located at the end 12 of the boom. The dimensions of the connecting sleeves 710 are not necessarily equal in length, their length could be adapted so as to configure the arrangement of the spraying bodies to match the plant target to be treated.

The boom section located at the end 11 of the boom is connected to a coupling sleeve 711. The series connection of the sleeve 711 with the boom sections 10 forms a circulation duct for a boom air flow.

Preferably, the connecting 710 and coupling 711 sleeves are made of a flexible material, for example a fabric provided with a sealed coating or a PVC tarpaulin. The connection of these sleeves 710, 711 with the spraying bodies 100 is also made tight enough to limit the boom air flow losses in the circulation duct, by means of a collar 720, for example, to make this connection easily dismountable. The flexible nature of the sleeves enables the boom to deform upon contact thereof with a rigid obstacle, thereby avoiding critical damages. Nonetheless, the sleeves may be made of a rigid material, thereby enabling an easier handling of the boom during assembly or mounting thereof on the agricultural sprayer, as well as positioning thereof in a horizontal or inclined position where it is difficult to withstand deformations due to the weight of the boom. The boom is fluidly connected to a source of a boom air flow, and preferably comprises, in the illustrated example, the source of a boom air flow such as a fan 3. Preferably, it consists of an axial fan driven by an electric motor. The fan 3 is configured to generate, inside the circulation duct of the boom 1, a boom air flow 350 whose pressure and flow rate are defined by the characteristics of the axial fan and the aerodynamics of the circulation duct. The fan 3 is accommodated inside a housing fluidly connected to the coupling sleeve 711 of the boom 1. The fan 3 may also be mounted axially inside the circulation duct of the boom 1, and preferably inside the coupling sleeve 711.

### Function and Structure of the Spraying Body 100

The function and the structure of the portion of the boom section 10 ensuring spraying will now be described in detail with reference to FIGS. 3A to 7B in which reference will not be made to the coupling sleeve, to the connecting sleeves or to the boom plug of the boom section, these elements serving as a connection and/or air flow duct between the boom section portions ensuring the spraying function.

The boom section 10 includes a spraying body 100 which is intended to act as a support structure for the spraying means, in particular for the nozzle 101, for the diffusers 301a, 301b as well as for the means for supplying and adjusting the diffused air flows 400a, 400b and of the product jet 200 that are associated therewith.

The nozzle 101 is configured so that the product jet 200 propagates towards the plant target 5 according to a median spraying axis 201, illustrated more specifically in FIGS. 3A to 5, indicating an average direction of propagation of the product jet, that being so whether the product jet flares out or not as it moves away from its source.

In the example of FIGS. 3A and 3B, the median spraying axis is substantially perpendicular to the preferred direction of advance 45. Nonetheless, the median spraying axis may be oriented differently towards the plant target at an angle different from 90 degrees with the preferred direction of advance, this orientation being done by the user before use of the boom through an appropriate adjustment of the orientation of the boom or of each boom section of the boom independently of each other.

The two diffuser assemblies 301a, 301b connected to the spraying body 100 are supplied with a gas, typically air, originating from the boom air flow 350 of the fan of the boom. Each diffuser 301a, 301b is configured to generate at the outlet 309a, 309b of the diffuser 301a, 301b a diffused air flow 400a, 400b propagating towards the plant target 5 and converging towards the median spraying axis 201.

The boom section 10 is configured to spray the product at a minimum recommended spraying distance Dr between the product outlet of the nozzle and the plant target. This distance Dr, shown only in FIGS. 1 and 3B, is the distance separating a plane Pp passing through the outlet of the nozzle and perpendicular to the median spraying axis of a plane Pr, parallel to the plane Pp. Hence, this minimum recommended spraying distance Dr is indicative, usually communicated by the manufacturer of the boom, to diffuse the product over the plant target so as to sweep it over its entire surface. Most often, the plant target is located at a distance from the nozzle larger than Dr along the median spraying axis to guarantee a good sweep of the surface to be sprayed and to take account of any pipe deviations. In FIGS. 1 and 3B, the median spraying axis 201 is in this example almost perpendicular to the plant target 5, and therefore the planes Pp and Pr are almost parallel to the plant target to be treated. As it has already been specified hereinabove, the median spraying axis can be adjusted angularly upstream or downstream of the plant target with reference to the preferred direction of advance, and it will be seen hereinafter that it can also be adjusted angularly with respect to the direction of the boom air flow 350 of the boom. In fact, the planes Pp and Pr are not systematically positioned parallel to the plant target and may also have different positions from one boom section to another, these planes as well as the distance Dr being referenced with respect to the median spraying axis 200 of each spraying element 101.

The nozzle 101 is located between the two diffusers 301a, 301b, preferably according to a preferred direction of advance 45 of the agricultural sprayer 4. This preferred direction 45 is illustrated in FIGS. 1, 3A and 3B and, in this example, the diffuser 301b diffuses its diffused air flow 400b upstream of the product jet 200 while the diffuser 301a diffuses its diffused air flow 400a downstream of the product jet 200. Thus, the convergence of the diffused air flows 400a and 400b allows channeling the product jet and ensuring a pinching thereof until collision of the diffused air flows so as to incorporate the drops of the product jet in the diffused air flows.

The boom section 10 is configured so that each of the diffused air flows 400a, 400b has:
a first portion 402a, 402b, so-called carrier air flow portion, converging towards each other and towards the median spraying axis 201. The first two portions 402a, 402b channel the product jet 200 up to intersection thereof, occurring upstream of the plane Pr. They constrict the product jet 200 until intersection thereof. It is also possible to qualify this constriction as pinching. Indeed, the outer envelope formed by the product jet 200, for example a cone, is deformed under the effect of the first two portions 402a, 402b. Each diffused air flow 400a, 400b in these portions is configured to force the deviation of the direction of the drops of the product jet 200 in the direction of the diffused air flow. Typically, each diffused air flow 400a, 400b in these portions actually has a sufficient air speed to force the deviation of the direction of the drops of the product jet 200 in the direction of the diffused air flow. In this first portion, the two diffused air flows thus incorporate the drops of the product jet 200 to convey them towards the plant target 5.
   a second portion 403a, 403b, so-called the collision portion, is located beyond the intersection of the first two portions 402a, 402b of the diffused air flows 400a, 400b.

To replicate these features, a person skilled in the art only needs to adjust the range and the respective orientations of these two air flows so as to create this intersection, which he/she could do without any difficulty.

Thus, the boom section 10 allows channeling and transporting the product jet 200 the closest to the plant target 5 and, by the collision of the diffused air flows 402a, 402b upstream of the plane Pr, therefore theoretically before reaching the plant target 5, slowing down and dispersing the drops more homogeneously in space in order to distribute them over the different surfaces of the plant target 5. Moreover, this collision avoids a drift of the product if the plant target is not very dense or discontinuous, the drops having an average speed, in projection on the median spraying axis 201, attenuated in the collision portion and insufficient to make them cross a distance much larger than that of the hedgerow. Thus, the invention allows rationalizing the consumption of products and avoiding an uncontrolled dissemination thereof outside the plant target 5.

Furthermore, the preliminary convergent channeling of the product jet 200 by the two diffused air flows 400a, 400b in the carrier air flow portion 402a, 402b allows limiting the influence of the disturbances due to the wind or to the speed of advance of the boom 1 section 10.

The spraying module 100 is configured so that the convergent propagation of each of the diffused air flows 400a, 400b intersects the median spraying axis 201 at a distance from the nozzle Db measured according to the median spraying axis 201, at the level of a plane Pb parallel to the plane Pp at a distance smaller than the distance Dr so that the turbulent air collision portions 403a and 403b sweep the plant target 5. Preferably, Db is smaller than or equal to 0.8 meters and preferably smaller than or equal to 0.4 meters.

FIG. 3C schematically illustrates, in front view, a simplified example of the propagation of the diffused air flows 400a, 400b and that of the product jet 200 according to the median spraying axis 201, in three planes illustrated in FIG. 3B: the previously defined planes Pp and Pb as well as an intermediate propagation plane Pf, parallel to the planes Pp and Pb. For simplicity, the shape of the diffused air flows 400a and 400b intersecting the same plane is depicted in a rectangular shape to illustrate an example of a flattened air jet propagating in a fan-like fashion, and the shape of the product jet is depicted in a circular manner to simulate an example of a conical jet, each circle representing the theoretical intersection of the product jet with the plane concerned without taking account of the presence of the diffused air flows.

At the level of the plane Pp, the product jet is diffused according to the median spraying axis initially inside a circle 200p having a diameter Xp. The diffused air flows intersect the plane Pp at a distance from the product jet 200p and are inscribed within elongated rectangular shapes 400ap, 400bp having a width Hp much larger than Xp. The two diffused air flows do not intersect the product jet at this level.

At the level of the intermediate plane Pf, the product jet intersects this plane within a circle 200f, with a diameter Xf, always centered on the median spraying axis 201. The two diffused air flows having a convergent orientation are now closer to the median spraying axis. In this example, they are inscribed within rectangular shapes 400af, 400bf with the size Hf larger than the size Hp during the emission, which size is always larger than the diameter Xf of the product jet. Nonetheless, at this level, first drops of the product jet have already encountered the diffused air flow, the distance between the two diffused air flows being smaller than the diameter Xf that the product jet would have without the presence of the diffused air flows.

At the level of the plane Pb, the two diffused air flows make their junction in the rectangular shape 400ab, 400bb, while having progressively pinched and incorporated the entirety of the product jet, which would be inscribed in the absence of diffused air flows in the circle 200b with the diameter Xb. The size Hb of the diffused air flow at this level is larger than the theoretical diameter Xb of the beam so as to incorporate the drops of the product jet. This convergent junction of the two diffused air flows associated with the drops of the product jet will then generate afterwards a turbulent collision flow.

As illustrated in FIGS. 3A and 3B, the boom section 10 is configured so that the diffused air flows 400a, 400b intersect the median spraying axis 201 at two contiguous areas or at the same area. This embodiment allows increasing the reach of the product jet 200 without modifying, at least without significantly modifying, its direction. This advantage is even more significant if the two diffused air flows 400a, 400b have identical flow rates and angles of incidence.

Alternatively, the boom section 10 is configured so that the diffused air flows intersect the median spraying axis 201 at two non-contiguous areas, separated from each other. This effect is achieved by imparting a different convergence angle between each diffuser 301a, 301b and the median spraying axis 201. Thus, the intersection of the diffused air flows 400a, 400b does not occur at the level of the median spraying axis. In addition to slowing down the product jet by the turbulences, this has the effect of further accentuating the slowing down by diverting the product jet from its main trajectory.

### Boom Section 10

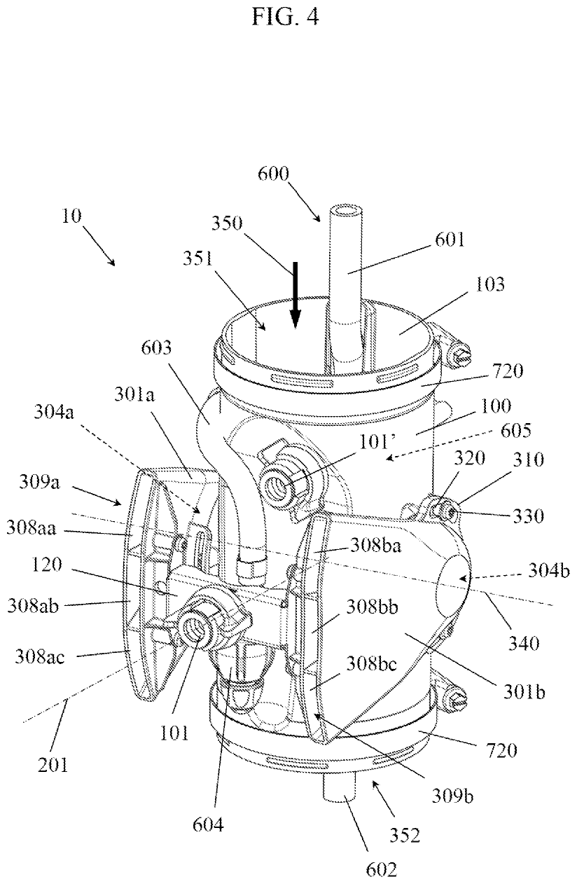

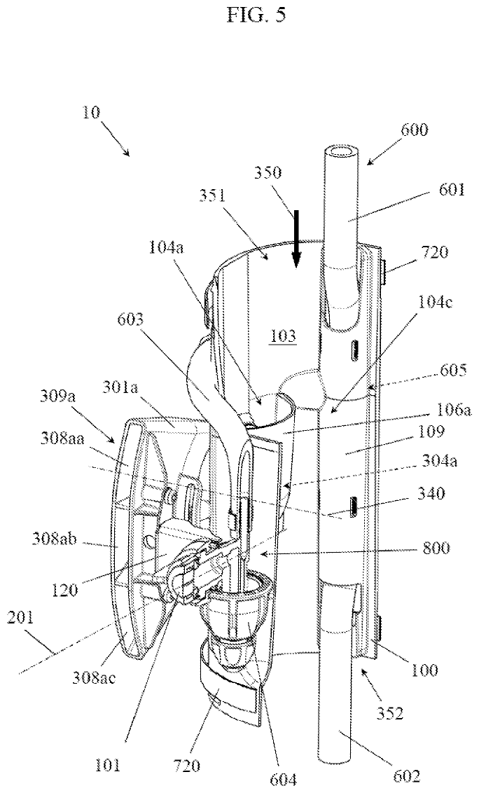

Referring to FIGS. 4 and 5, the boom section 10 will now be described in more detail.

The boom section 10 comprises a spraying body 100, a nozzle 101 and diffusers 301a, 301b. Preferably, the spraying body 100 is rigid, i.e. it does not deform manually so as to support the spraying means associated with the boom section 10. Also preferably, the spraying body 100 is tubular. It has a body inlet 351, a body outlet 352 and can be crossed by the boom air flow 350. A tubular portion 103 extends from the body inlet 351 up to the body outlet 352. The inlet 351 is configured to be fluidly connected to a coupling sleeve 711, for example with a clamping collar 720 if the sleeve is flexible, if it is connected to the fan of the boom, or to a connecting sleeve 710, herein again with a clamping collar 720 if the sleeve is flexible, of another boom section, the sleeves not being shown in the figures. The same applies to the body outlet 352 which may be fluidly connected to a coupling sleeve 710 or to a boom plug 712 if it is the last boom section of the boom. Thus, the boom air flow 350 generated by the fan 3 propagates in the tubular portion 103 of the spraying body 100, which allows dispensing with a pipeline dedicated for the boom air flow flowing through the boom 1. This primarily allows having a compact assembly that can be easily configured with regards to the number of boom sections and the distance between each boom section but also increasing the robustness and the reliability of the boom.

### Diffusers 301a, 301b

The spraying body 100 has two openings 304a, 304b through the wall of the tubular portion 103, respectively associated with one of the diffusers 301a, 301b.

Each diffuser 301a, 301b has an inlet fluidly coupled to an opening 304a, 304b associated therewith and a guide section shaped so as to guide the portion of the boom air flow 350 from the opening 304a, 304b up to an outlet 309a, 309b of the diffuser 301a, 301b. Preferably, the guide section is tubular, which allows guiding the diffused air flow more effectively.

The diffusers 301a, 301b are located on either side of the nozzle 101 with respect to a median plane comprising the median spraying axis 201 and the direction of the boom air flow 350. Preferably, the diffusers 301a, 301b are located at an equal distance from the nozzle 101.

Preferably, the diffusers 301a, 301b are identical and formed in one-piece. Thus, the same part may be used alternately for either one of the diffusers. This allows reducing the number of references to make the same boom section, which limits the manufacturing and logistics costs.

The diffusers 301a, 301b have at least one fastening excrescence 310 including an aperture 320 enabling fastening on the spraying body 100 by means of screws 330, the aperture 320 enabling angular fastening of the diffuser on the body with a margin for pivoting about a pivot axis 340.

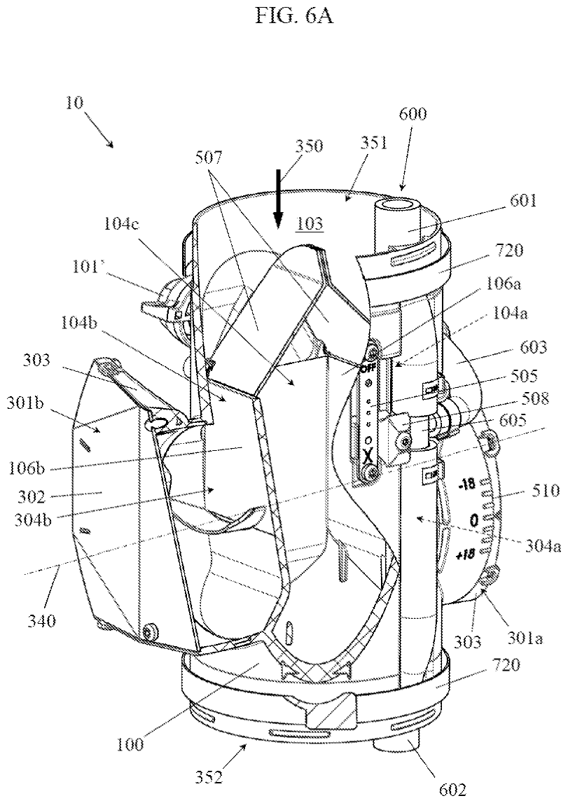

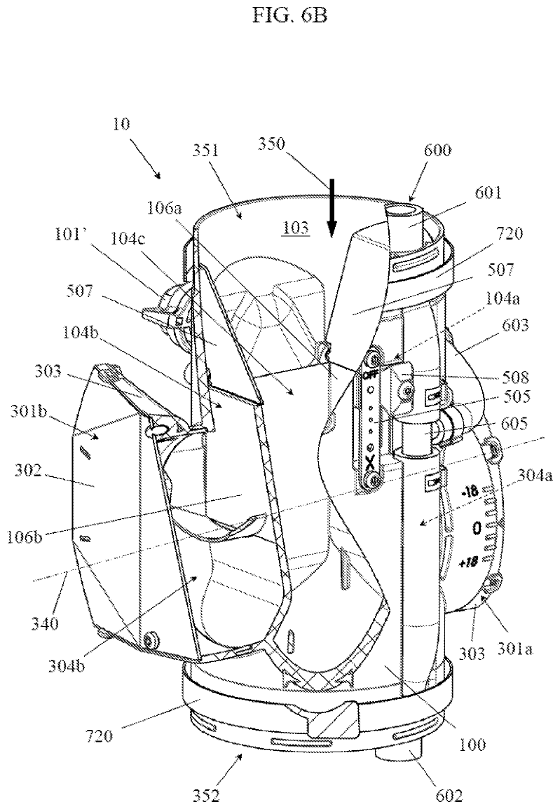

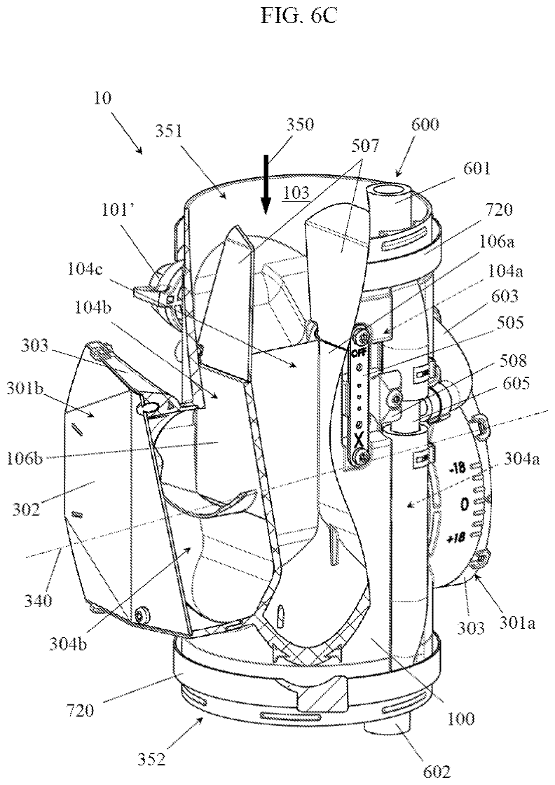

FIGS. 6A to 6C show another embodiment of the diffusers made into two portions and including a diffuser body 303 associated with a flange 302. This flange 302 has the interest of mounting the diffusers without any excrescence outside the diffuser.

According to a non-limiting example, the diffuser 301a, 301b has:
a proximal chamber extending from the inlet of the diffuser and in fluid communication with one of the openings 304a, 304b of the spraying body 100,
a distal chamber extending from the proximal chamber and up to the outlet 309a, 309b of the diffused air flow.

At least the distal chamber has several channels 308aa, 308ab, 308ac, 308ba, 308bb, 308bc, illustrated in FIGS. 4 and 5, configured to separate the diffused air flow flowing in the diffuser 301a, 301b into several diffused air flow portions, the channels 308ab and 308bb being oriented in a direction convergent with the median spraying axis 201. These channels are referenced in FIGS. 4 and 5. Each channel 308aa, 308ab, 308ac, 308ba, 308bb, 308bc forms a diffused air flow portion generated at a homogeneous speed so as to limit the formation of air shears and turbulences at the outlet of the diffusers despite the pressure drops to divert the portion of the boom air flow 350 derived from the spraying body 100 in each diffuser to orient it towards the plant target. The portions 308aa, 308ab, 308ac, 308ba, 308bb, 308bc, form carrier air flow portions 402a, 402b. Preferably, the channels generate air flow portions diffused in non-parallel directions at the outlet of each diffuser and have elongated shapes so that the diffused air flow derived from the proximal chamber is projected at the outlet of the diffuser to form a fan-like shaped air blade. Each diffused air flow portion may be organized in non-parallel planes so as to form a diffused air flow at the outlet of the diffuser curved towards the median spraying axis, the curvature being viewed in a plane perpendicular to the median spraying axis. Indeed, in the absence of channels, there is a risk of obtaining an air speed profile at the outlet of the diffuser that is too disparate generating significant turbulences in the carrier air flow portion 402a, 402b, such turbulences being undesired at this stage.

Thus, the distal chamber has a central channel and two peripheral channels which extend from the proximal chamber to form carrier diffused air flows in the form of flat or curved fan-like shaped air blades.

Thus, each diffused air flow behaves like an air flow barrier to the product jet. Given the minimum recommended spraying distance, the collision portions generated by the diffused air flows associated with the product jet, derived from the different boom sections of a boom, reach the plant target and are at least contiguous in order to sweep the entirety of the surface of the plant target.

Of course, it clearly appears that all of the features related to the channels can be exploited and claimed independently of the features related to the air flows forming air flow portions which intersect the median spraying axis as well as the features related to the pivot axis.

### Adjustment of the Diffused Air Flow Rate

FIGS. 6A to 6C show a partial cut-away of the boom section 10 and show a device for adjusting the air flow rate 350 extracted towards the diffusers 301a, 301b, in the tubular portion 103 of the spraying body 100.

The spraying body 100 includes, in its tubular portion 103, wall portions 106a, 106b dividing the distribution of the boom air flow 350 into the tubular portion 103 into 3 portions 104a, 104b and 104c, the portion of the boom air flow passing through the portions 104a, 104b being oriented towards the respective openings 304a, 304b of the spraying body 100 and the portion of the boom air flow 350 passing through the portion 104c located at the body outlet 352.

Alternatively, the spraying body 100 could include only one single wall 106 dividing the distribution of the boom air flow 350 into two portions 104 and 104c, the portion 104 being intended to supply the two openings 304a, 304b of the spraying body 100, the portion 104c communicating with the body outlet 352.

This adjustment device includes at least one flap 507 movably mounted inside the spraying body 100 and configured to vary, according to its position in the spraying body 100, the portion of the boom air flow 350 passing through the portions 104a, 104b to reach the diffusers 301a, 301b. Preferably, the adjustment device comprises two flaps, one for each diffuser 301a, 301b.

Each flap 507 can take on:
an opening position in which it channels most of the boom air flow 350 towards the portions 104a, 104b of the spraying body 100 while limiting, and even preventing the passage of the boom air flow 350 in the portion 104c and therefore towards boom sections 10 located downstream of the boom 1. This position is illustrated in FIG. 6A. In this example, the flap 507 is remote from the inner face 103 of the body 100. Thus, it allows access to a fixed channeling portion 104a, 104b leading to the openings 304a, 304b;
a sealing position in which most, and even all of the boom air flow 350 passes through the portion 104c and almost no portion of the boom air flow passes through the portions 104a, 104b supplying the associated diffusers 301a, 301b. This position is illustrated in FIG. 6B. The flap 507 is pressed against the inner face 103 of the spraying body 100.

FIG. 6C illustrates an intermediate position of the flap 507, enabling a balanced distribution of the boom air flow between the diffusers 301a, 301b on the one hand and a boom section 10 located downstream, then supplied by the portion of the boom air flow 350 accessing the portion 104c and arriving at the outlet of the body 352.

Thus, this adjustment device allows adjusting, for each boom section 10, the flow rate of air carrying the drops towards the plant target. It also allows adjusting the flow rate at the outlet of the outlets 309a, 309b of the diffusers 301a, 301b of the boom 1 despite different pressure drops at the level of each boom section 10 according to its position in the boom 1 with respect to the fan 3.

The position of the flaps 507 is controlled from outside the boom section 10 on the spraying body 100 by an adjustment member 508 which can be handled by a user. For example, the movable flaps are connected to this adjustment member 508 by connecting rods, not shown in the figures. Advantageously, it is provided for the position of this member 508 being viewable with respect to a graduation 505 of the opening angle index of the flap 507. Typically, this graduation 505 may be in the form of a graduated ruler along which a button forming the adjustment member 508 slides. Preferably, one single adjustment member 508 simultaneously varies the position of the flaps 507 of the diffusers 301a, 301b of the spraying body 100.

### Duct for Supplying the Product to be Sprayed

The boom section 10 comprises a main duct 600 for supplying the product to be sprayed. The nozzle 101 is supplied with product via a bypass duct 603, fluidly connected to the main duct 600 via a connector 605. The main duct 600 has an upstream portion 601 located upstream of the connection with the bypass duct 603 relative to the flow of the product in the boom 1 section 10, and a downstream portion 602 located downstream of this connection. According to an advantageous example illustrated in FIGS. 4 and 5, the main duct 600 is accommodated essentially inside the air pipe of the boom and therefore inside the sleeves 710, 711. Preferably, only one portion of the main duct 600 passes through the air pipe of the boom at the level of the spraying body 100 of a boom section 10 so as to supply the nozzle 101 through a bypass duct 603. This allows protecting the main duct 600 in particular from ultraviolet radiations and avoiding it being hit or torn off by obstacles such as vegetation elements encountered during the movement of the boom 1. For example, it may be provided for the outer face of the body 100 having a recess or a housing 109, visible more particularly in FIG. 5, to keep the main duct 600 outside the spraying body 100 while remaining within the bulk of the spraying body 100. This housing may also be formed by a sheath, with a closed section or not, located inside the body 100, and forming, for example, projecting from the inner face 103 of the body 100. Thus, the main duct 600 does not project beyond the outer face of the body 100. This allows further reducing the risks of snagging and tearing of the main duct 600. In fact, the main duct 600 has junctions only outside the air pipe and more particularly outside the spraying bodies 100 of the boom sections 10. This allows facilitating access to the bypass duct 603 and checking for any leaks in the junctions of the main duct 600, in particular at the level of the connectors 605.

Alternatively, it may be provided for the main duct 600 being fastened on an outer face of the spraying body 100.

The main duct 600 and the bypass duct 603 may be flexible, i.e. they can be elastically deformed by manual force, for example to assemble them in the section 10 of the boom 1.

The bypass duct 603 is connected to the main duct 600 via a junction external to the wall of the body 100 to reach the nozzle 101, in this case the connector 605 is “T”-shaped. The connection between the end of the bypass duct 603 and the nozzle 101 may be ensured by any conventional connector. Preferably, an anti-drip drain valve 800, also serving as a nozzle carrier, is provided. Thus, it connects the bypass duct 603 to the nozzle while including members 604 serving as a tap, as a drain device and as an anti-drip device.

### Pivoting of the Diffusers

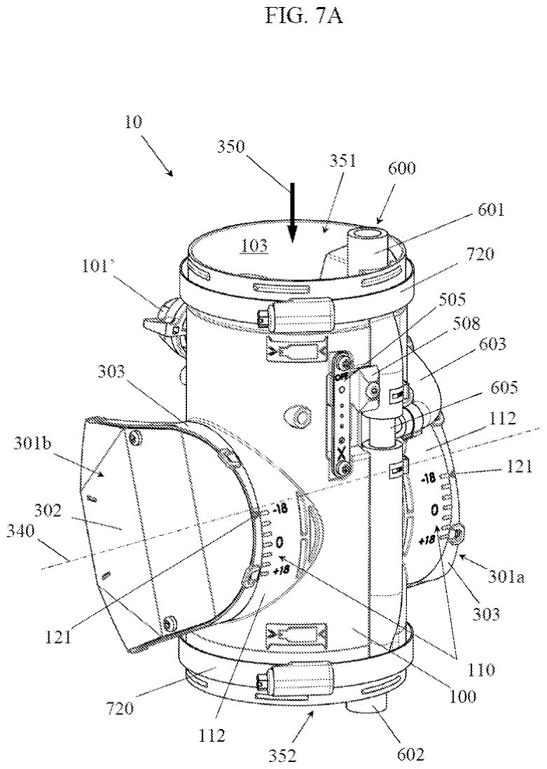

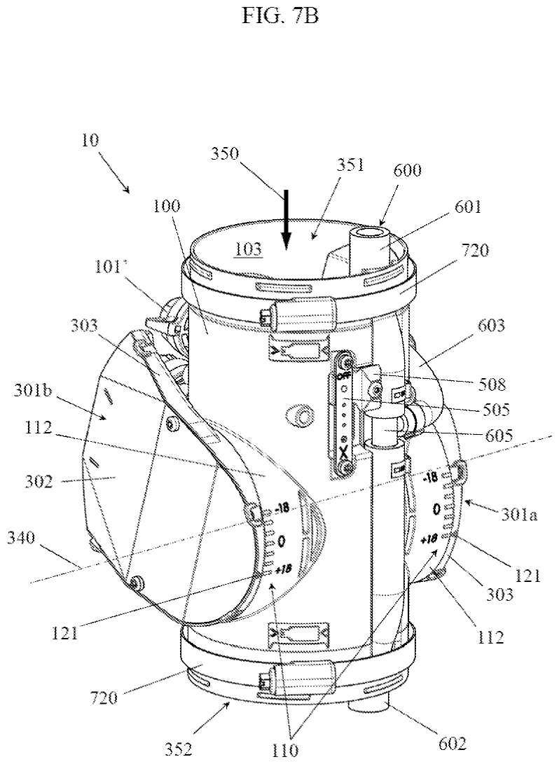

According to an advantageous embodiment illustrated in FIGS. 7A and 7B, the diffusers 301a, 301b are mounted movable in rotation on the spraying body 100. For example, they are pivotably mounted on a baseplate 112 formed by the spraying body 100. This pivoting allows adjusting the direction of propagation of the diffused air flows 400a, 400b at the outlet of the diffuser to adapt it to the typology of the plant target 5. Preferably, this pivoting is performed about a pivot axis 340, substantially perpendicular to the direction of the boom air flow 350 passing through the boom section 1. In other words, and as it appears from the explanations hereinabove and from the figures, this pivoting is performed about a pivot axis 340, substantially perpendicular to the direction of the boom air flow 350 passing through the spraying body 100. This pivot axis 340 is substantially perpendicular to the direction according to which the spraying body 100 extends from its inlet 351 up to its outlet 352.

This allows favoring a direction of the diffused air flow at the outlet of the diffuser towards the root or towards the top of the plant target 5 in vertical use of a boom along a hedgerow. Preferably, the angular sector that this pivoting can sweep is comprised between −45° and +45°, and more preferably between −20° and +20°.

The pivot axis 340 is configured to enable a rotation of the two diffusers 301a, 301b so that the diffused air flows 400a, 400b sweep an angular sector, this angular sector being contained in a plane, preferably a vertical plane.

Preferably, this pivot axis 340 is parallel to the preferred direction of advance 45 of the agricultural sprayer 4.

When the boom section comprises a sleeve 700, the latter extends according to a preferred direction which is perpendicular to the pivot axis.

According to one example, the connecting sleeve 700 is connected to the spraying body 100, the air flow flowing from an inlet of one amongst the spraying body 100 and the connecting sleeve 700 to an outlet of the other one amongst the body 100 and the connecting sleeve 700 according to the direction of the boom air flow 350.

Preferably, the nozzle 101 is secured to the two diffusers 301a, 301b in their rotation about this axis. The angular orientation of the nozzle 101 is controlled by that of the diffusers 301a, 301b. Thus, the relative direction of the product jet 200 and of the diffused air flows 400a, 400b is preserved irrespective of the angular pivoting imposed on the diffusers 301a, 301b. For this purpose, it may be provided for the nozzle 101 being located at a distance from the spraying body 100 of the boom section 10, on a support part 120 such as a rigid bar. This support part 120 connects the two diffusers 301a, 301b. Thus, a pivoting imposed on one of the two diffusers automatically causes a pivoting by the same magnitude of the other diffuser and of the nozzle 101.

The pivot axis 340 is configured to enable a rotation of the spraying element 101 so that the product jet 200 tilts in a plane perpendicular to the median spraying axis 201 according to which the product jet 200 propagates. The pivot axis 340 is perpendicular to the median spraying axis 201 according to which the product jet 200 propagates.

Thus, the pivot axis 340 is configured to enable a rotation of the spraying element 101 so that the median spraying axis 201 sweeps an angular sector, this angular sector being contained in a plane, preferably a vertical plane. Preferably, this vertical plane is perpendicular to the preferred direction of advance 45 of the agricultural sprayer 4.

In order to accurately control the angular position of the diffusers 301a, 301b, it is provided for one amongst the body 100 and the movable assembly 120, 301a, 301b, 101 bearing an angular marker 121 which moves opposite a graduation 110 of the rotation angle index borne by the other one amongst the body 100 and the movable assembly 120, 301a, 301b, 101.

In the example illustrated in FIG. 7A, the angular orientation of the diffusers corresponds to an angle of −18° to orient the diffused air flows and the product jet 200 in the direction of the bottom of the plant target 5. In the example illustrated in FIG. 7B, the angular orientation of the diffusers corresponds to an angle of +18° to orient the diffused air flows and the product jet 200 in the direction of the top of the plant target 5.

Of course, it clearly appears that all of the features related to the rotation of the diffusers 301a, 301b and/or of the spraying element 101 can be exploited and claimed independently of the features related to the air flow forming air flow portions which intersect the median spraying axis.

This allows accurately treating a large surface area of plants while keeping a limited bulk.

Besides the fact that the vegetation surface to be treated is accurately covered, it is possible to configure the spraying directions of each nozzle to reflect, with all of the nozzles of a boom, the geometry of the hedgerow to be treated. For example, the proposed boom section allows simultaneously treating the lateral face, the bottom and the top of a hedgerow and that being so while adapting to the height of the latter.

### Boom Structure, Boom and Agricultural Sprayer

As indicated hereinabove, two boom 1 sections 10 are connected together by the connecting sleeve 710 of one of the boom sections, preferably flexible; and the first boom section is connected to the fan by the coupling sleeve 711, which may also be flexible. Thus, the boom is not completely rigid and can easily deform when it encounters an obstacle. Typically, it can deform, at least at the level of the flexible sleeves 710, 711 under the effect of its own weight. Thus, it can permanently adapt to the configuration of the terrain and keep a substantially vertical orientation despite the declivities of the terrain.

Finally, the spraying boom 1 does not need an additional support structure to support the boom sections 10, these forming the boom 1 by simple connection therebetween at the level of their connecting sleeve 710 or the coupling sleeve 711. Thus, the boom sections 10 are supported only by the sleeves 710, 711.

The boom comprises at least one, and preferably at least two, boom sections 10 connected by their connecting sleeve 710 and arranged in series so that a portion of the diffused air flow supplying a first boom section 10 passes therethrough to supply a second boom section 10 downstream of the boom 1. Of course, it clearly appears that all of the features related to the series arrangement of the boom sections 10 as well as the arrangement of the fans can be exploited and claimed independently of the features related to the air flows forming air flow portions which intersect the median spraying axis as well as the features related to the pivot axis.

Each spraying body 100 of a boom section 10 is removably mounted on the boom by means of the collars 720 and the interconnection external to the spraying body 100 of the main duct 600. Afterwards, the adaptation of the length of the sleeves 710, 711, associated with the length of the main duct 600, allows easily adapting the configuration of the boom (for example the number and the arrangement of the boom sections on the same boom) according to the plant target and the amount of treatment to be sprayed. Furthermore, in case of failure of a boom section, its constituent elements can be easily replaced without having to replace the entire boom.

The outer wall of the body 100 may also include a housing or a support for fastening thereto a second nozzle 101′ which may be either a spare nozzle, or a nozzle of different caliber or a nozzle of different type (anti-drift for example) to enable easy replacement of the nozzles 101 in case of a plugged nozzle or when switching from one field to another with different treatment conditions. Moreover, the evolutions in the legislation impose the use of particular nozzles depending on the circumstances, for example anti-drift nozzles in the proximity of homes or water courses. The pre-arrangement of these nozzles at the same level of the boom section considerably facilitates the replacement of nozzles and above all allows verifying easily whether all nozzles have actually been switched on each boom section.

The agricultural sprayer integrating the boom 1 may be self-propelled or towed. It may comprise one boom 1 or more, for example four like that one illustrated in FIG. 1. Preferably, each boom 1 is connected to a fan 3, the air flow rate of which can be adjusted independently of that of the other boom 1. Thus, it is possible to adjust the flow rate/pressure parameters of the boom air flow delivered in each of the booms 1 independently. Afterwards, it is possible within the boom to adjust the diffused air flows delivered by the diffusers 301a, 301b of each of the boom sections 10, for example according to the position of the boom with respect to the plant target 5. This allows further improving the effectiveness of the deposition of the product over the plant target 5. Moreover, in comparison with a solution comprising one single fan supplying several booms, the proposed solution avoids generating different pressure drops towards each of the booms, given the lengths and the shapes of the duct required to convey the boom air flow.

Preferably, at the outlet 309a, 309b of the diffusers 301a, 301b, the speed of each diffused air flow allows conveying the product drops very rapidly towards the plant target without these having the time to dry between diffusion thereof and application thereof. Preferably, the air speeds at the outlet 309 of the diffuser 301 are in the range of 40 to 50 m/s.

Preferably, the spraying nozzle 101 emits a product jet designed to flare out, at least in a plane comprising the median spraying axis and the direction of the boom air flow of the boom. This flaring is comprised within an angular range in the range of 80 to 90 degrees. Given the recommended minimum spraying distance, this leads to sweeping the plant target over a minimum width defined by this angular range. The portions of carrier air flows are configured to channel the product jet by having a diffused air flow width constantly larger than the width of the product jet at any position along the median spraying axis and in a plane perpendicular to the latter. Therefore, to cover the entirety of the plant target, several nozzles 101 are necessarily uniformly distributed on the same boom 1. In practice, at least two nozzles are positioned and most often three or four, and even more according to the size of the plant target 5.

Preferably, the boom sections 10 of the boom 1 are arranged so that the different carried jets cover at least 60% of the height of the hedgerow 51, preferably at least 75% and preferably over the entire height of the hedgerow 51. All these jets form a preferably continuous brush which progressively sweeps the plant target 5 according to the rate of advance of the boom relative to the plant target 5. The angular orientation of the diffusers 301a, 301b allows adjusting the dimension of the brush and therefore the coverage of the plant target 5, that being so according to the number of boom 1 sections 10.

The product is conveyed under pressure at the level of each boom section 10 in order to be micronized therein in the form of drops, and then conveyed and directed towards the vegetation by the diffused air flows. Typically, the pressure of the product inside the main duct is comprised between 1 and 15 bar depending on the used nozzle type.

Thus, the proposed boom 1 has a modular design. Each boom section 10 comprises an air inlet and an air outlet, means for adjusting the flow rate as well as the orientation of the diffused air flow, each boom section 10 connecting with another boom section upstream or downstream of the boom via a flexible sleeve, for example.

In this embodiment, the spraying body 100 of a boom section 10 forms a one-piece part. According to an alternative embodiment illustrated in FIG. 8, the boom 1 has only one boom section 10 including, conversely, several spraying elements 301a, 301b, 101 as described hereinabove. The boom section 10 further includes a rigid spraying body 100a, 100b, made into two longitudinal portions, forming the air pipe upon assembly thereof. This embodiment just enables an easier mounting of the sets of nozzles, diffusers as well as of the main duct, these elements preserving the above-described features. This embodiment is more suited to a horizontal or inclined position of the spraying booms so as to avoid in this case the excessive deformations of the boom due to its own weight.

With regards to the previous description, it clearly appears that the proposed solution allows considerably improving the deposition of drops of the product over a plant target, whether it consists of viticulture, arboriculture or market-gardening culture.

The invention is not limited to the previously-described embodiments and extends to all of the embodiments covered by the invention. The present invention is not limited to the previously-described examples. Many other variants are possible, for example by combination of previously-described features, without departing from the scope of the invention. Furthermore, the features described with regards to one aspect of the invention may be combined with another aspect of the invention.

In particular, although in the illustrated examples, the spraying boom 1 extends mainly according to the vertical, the invention also covers the embodiments wherein the spraying boom extends mainly according to a direction inclined with respect to the vertical. In particular, this direction may be horizontal.

Preferably, the fluid flows are air flows even though it is perfectly possible to consider another gas being substituted for air.

1. A section of a boom for spraying a product over a plant target for example a vine, the boom section comprising:
at least one spraying element configured to be fluidly supplied with product and to generate a product jet propagating towards the plant target according to a median spraying axis;
two diffusers each configured to be supplied with a gaseous fluid such as air and each configured to generate at the diffuser outlet a diffused air flow propagating towards the plant target according to a diffused air flow direction, the spraying element being located between the two diffusers wherein the boom section comprises a spraying body, the diffusers being pivotably mounted on a baseplate formed by the spraying body, this pivoting being performed about a pivot axis substantially perpendicular to a direction of the boom air flow passing through the boom section, the boom section being configured so that each of the diffused air flows has a first portion which intersects the median spraying axis, each of the diffused air flows having a second portion extending the first portion beyond a point of intersection with the median spraying axis.

2. The boom section according to claim 1, configured so that the median spraying axis intersects the diffused air flows at a distance Db from the spraying element smaller than or equal to 0.8 meters and preferably smaller than or equal to 0.4 meters.

3. The boom section according to claim 1, wherein the pivot axis is perpendicular to the median spraying axis according to which the product jet propagates.

4. The boom section according to claim 1, wherein the spraying element and the diffusers are rotatably mounted on the body so as to be orientable about said pivot axis, the spraying element and the diffusers being mutually secured in rotation about this pivot axis.

5. The boom section according to claim 1, wherein the body comprises a support part extending from one diffuser to another and carrying the spraying element.

6. The boom section according to claim 1, configured so that each of the diffused air flows intersects the median spraying axis in two contiguous areas or in the same area, preferably at the same point.

7. The boom section according to claim 1, wherein the spraying body forms a tubular portion having at least one inlet and at least one outlet between which a boom air flow flows and at least one supply opening of the diffusers to generate the diffused air flows.

8. The boom section according claim 7, wherein the body is configured to support a main duct for supplying the spraying element with product, the spraying body being configured so that the main duct passes through at least one inlet and an outlet of the body or is accommodated within a housing formed on an outer face of the body.

9. The boom section according to claim 8, wherein the main duct is accommodated inside a housing formed on an outer face of the body and so that the main duct does not project beyond the outer face of the body.

10. The boom section according to claim 1, wherein at least one diffuser of the two diffusers has a proximal end by which it is rotatably mounted on the body and a distal end forming at least one outlet for the diffused air flow, the at least one diffuser further has an outer flange, a wall of which channels part of the diffused air flow as it passes inside the at least one diffuser, the outer flange preferably having a curved shape tending to approach the distal end to the body.

11. The boom section according to claim 1, wherein at least one diffuser of the two diffusers has:
a proximal chamber extending from the proximal end of the at least one diffuser and in fluid communication with one of the supply openings of the body;
a distal chamber extending from the proximal chamber and up to the outlet of the diffused air flow, at least the distal chamber having several channels configured to separate the diffused air flow flowing in the at least one diffuser at several diffused air flow portions, each channel forming a diffused air flow portion, one of the portions of said first portion intersecting the median spraying axis.

12. The boom section according to claim 1, wherein the body includes a device for adjusting the diffused air flow at the outlet of the diffuser, the adjustment device including at least one flap movably mounted inside the body and configured to vary, according to its position in the body, the portion of the boom air flow present inside the body and which reaches at least one diffuser of the two diffusers through the supply openings.

13. The boom section according to claim 12, wherein the body comprises an adjustment member which can be handled by a user from outside the body and configured to vary the position of the at least one flap.

14. The boom section according to claim 1, comprising at least one connecting sleeve connected to the spraying body and configured so that the boom air flow flows from one inlet of one amongst the spraying body and the connecting sleeve to an outlet of the other one amongst the body and the connecting sleeve according to the boom air flow direction.

15. A spraying boom comprising at least one boom section according to claim 1, at least one fluid source for generating the boom air flow and at least one coupling sleeve for fluidly connecting the source to the at least one boom section, the at least one sleeve and the at least one boom section forming a duct for the flow of the boom air flow within the boom.

16. The boom according to claim 15, wherein the fluid source is a fan preferably the fan is mounted inside the flow duct of the boom.

17. The boom according to claim 15, comprising at least two boom sections and preferably at least three boom sections, connected to each other by their connecting sleeve and arranged in series so that part of the boom air flow supplying a first boom section passes therethrough up to the last boom section while supplying the different diffusers.

18. An agricultural sprayer, self-propelled or towed, equipped with at least one boom according to claim 15.

19. The agricultural sprayer according to claim 18, comprising at least two booms, each boom having a fan whose air flow rate can be adjusted independently of that of the other boom.

20. The agricultural sprayer according to claim 19, wherein the fan of each boom is an axial fan mounted at one end of the boom in a main axis of extension of the boom using the coupling sleeve or integrated directly into a cylindrical portion of the duct for the flow of the boom air flow of the boom.

21. The agricultural sprayer according to claim 18, configured so that the median spraying axis intersects the diffused air flows at a distance Db from the spraying element, with Db≤Dr, Dr being a minimum spraying distance recommended by the manufacturer, measured according to the median spraying axis between the spraying element and the plant target.

22. A method for spraying a product over a plant target using a boom according to claim 15, wherein:
the spraying element is supplied under pressure with the product to generate a jet of the product propagating towards the plant target according to a median spraying axis;
the two diffusers are supplied with a gaseous fluid such as air and to generate at the outlet of each diffuser a diffused air flow propagating toward the plant target according to a diffused air flow direction;
each of the diffused air flow intersects the product jet in a collision area preferably located upstream of the plant target with respect to the median spraying axis.

23. The method according to claim 22, wherein the first portions of diffused air flow converge and each forms a carrier air flow channeling the product jet up to the point of intersection thereof with the median spraying axis, and then generate turbulences beyond the point of intersection thereof with the median spraying axis.

24. The method according to claim 22, wherein the median spraying axis intersects the diffused air flows at a distance Db from the spraying element, with Db≤Dr, Dr being a minimum spraying distance recommended by the manufacturer, measured according to the median spraying axis between the spraying element and the plant target.

25. The method according to claim 22, wherein the two diffusers are supplied simultaneously, one of the two diffusers is positioned upstream of the spraying element and the other one of the two diffusers is positioned downstream of the spraying element according to the direction of travel of the boom.
